(19) United States
(12) Patent Application Publication
(10) Pub. No.: US 2012/0146969 A1
(43) Pub. Date: Jun. 14, 2012

(54) SCANNING SIGNAL LINE DRIVE CIRCUIT AND DISPLAY DEVICE INCLUDING SAME

(75) Inventors: Mayuko Sakamoto, Osaka-shi (JP); Masashi Yonemaru, Osaka-shi (JP); Kenichi Ishii, Osaka-shi (JP); Masahiko Nakamizo, Osaka-shi (JP)

(73) Assignee: SHARP KABUSHIKI KAISHA, Osaka-shi, Osaka (JP)

(21) Appl. No.: 13/391,840

(22) PCT Filed: Mar. 16, 2010
(86) PCT No.: PCT/JP2010/054386

§ 371 Date: Feb. 23, 2012

(30) Foreign Application Priority Data
Aug. 31, 2009 (JP) 2009-200320

(51) Int. Cl. G09G 5/00

(52) U.S. Cl. 345/204

(57) ABSTRACT

A gate driver is implemented that includes an easily testable shift register to improve panel yields. In a monolithic gate driver including a shift register that operates based on 4-phase clock signals, each stage of the shift register is provided with an inter-stage connecting wiring line for receiving a clock signal other than clock signals received from a clock signal trunk wiring line, from a different stage than the stage; and a contact that connects a wiring line formed on the stage to the inter-stage connecting wiring line. The shift register is grouped every four consecutive stages. Markings formed of different numbers of planar-view circular-shaped structures are formed on bistable circuits of four stages included in each group such that the same type of marking appears every four stages.

### TECHNICAL FIELD

The present invention relates to a scanning signal line drive circuit of an active matrix-type display device, and more specifically to a layout of a shift register provided in a scanning signal line drive circuit.

### BACKGROUND ART

Conventionally, there is known an active matrix-type display device in which a plurality of gate bus lines (scanning signal lines) and a plurality of source bus lines (video signal lines) are arranged in a grid pattern and a plurality of pixel formation portions are arranged in a matrix form at the respective intersections of the plurality of gate bus lines and the plurality of source bus lines. Each pixel formation portion includes a TFT (Thin Film Transistor) which is a switching element connected at its gate terminal to a gate bus line passing through a corresponding intersection, and connected at its source terminal to a source bus line passing through the intersection; a pixel capacitance for holding a pixel value; and the like. The active matrix-type display device is also provided with a gate driver (scanning signal line drive circuit) that drives the plurality of gate bus lines, and a source driver (video signal line drive circuit) that drives the plurality of source bus lines.

A video signal indicating a pixel value is transmitted through a source bus line. However, each source bus line cannot transmit video signals indicating pixel values for a plurality of rows at a time (simultaneously). Therefore, writing of video signals to the pixel capacitances in the above-described pixel formation portions arranged in a matrix form is sequentially performed row by row. Hence, in order that the plurality of gate bus lines can be sequentially selected for a predetermined period, the gate driver is composed of a shift register including a plurality of stages.

Conventionally, in many cases, a gate driver is mounted in an area around a substrate forming a panel of a display device, as an LSI (Large Scale Integration). However, in recent years, formation of a gate driver directly on a substrate has been done. Such a gate driver is called a “monolithic gate driver”, etc., and a panel including a monolithic gate driver is called a “gate driver monolithic panel”, etc. According to such a gate driver monolithic panel, the number of components is reduced over conventional panels, enabling to achieve miniaturization and a reduction in power consumption.

Note that in connection with an invention of this matter, Japanese Patent Application Laid-Open No. 4-51216 discloses an invention pertaining to a liquid crystal panel having a marking provided on a part of the panel. According to the invention, a marking is formed, for example, at a suitable location in a terminal area. Then, when there is a change in fabrication steps, a change in material, a change in fabrication machine, or the like, the location, size, and shape of the marking is changed. By this, even if a liquid crystal panel is a completed structure, the content of fabrication conditions can be grasped.

### PRIOR ART DOCUMENT

### Patent Document

[Patent Document 1] Japanese Patent Application Laid-Open No. 4-51216

### SUMMARY OF THE INVENTION

### Problems to be Solved by the Invention

However, at a fabrication stage of a gate driver monolithic panel, failures such as wire breaking and leakage may occur in a shift register. The shift register includes a plurality of stages, and if such failures occur in a certain stage, then a signal is not transmitted normally to stages subsequent to the stage where the failures have occurred. As a result, abnormalities in panel operation occur. In addition, in a gate driver monolithic panel, the pattern density (the proportion of a region where a wiring line pattern is formed and a region where circuit elements are provided, in the whole region on a substrate) of a portion where a shift register is formed is higher than that of a portion where pixel circuits are formed. This is because in the portion where the pixel circuits are formed, the area occupied by a wiring pattern and circuit elements is minimized to increase the aperture ratio; on the other hand, in the portion where the shift register is formed, formation of a wiring pattern and circuit elements is performed in the narrowest possible region to achieve a narrow picture-frame. As such, in the gate driver monolithic panel, since the pattern density of the portion where the shift register is formed is high, failures in the shift register such as those described above occur relatively easily. Furthermore, in the gate driver monolithic panel, since the arrangement of circuit elements and a wiring pattern in the shift register is complex, when a failure occurs, it is difficult to identify a cause of the failure. As described above, in the gate driver monolithic panel, a failure in the shift register occurs relatively easily and it is difficult to identify a cause of the failure and thus yields are relatively low.

An object of the present invention is therefore to implement a gate driver including an easily testable shift register to improve panel yields.

### Means for Solving the Problems

A first aspect of the present invention is directed to a scanning signal line drive circuit of a display device that drives a plurality of scanning signal lines arranged in a display unit, the circuit comprising:

a shift register including a plurality of stages and sequentially shifting a pulse provided to a first stage from the first stage to a last stage based on a plurality of clock signals provided to each stage, the shift register being for driving the plurality of scanning signal lines, wherein

the shift register is grouped every k consecutive stages,

k stages included in each group of the shift register are provided with different types of marks from each other, and

the marks are of same types every k stages of the shift register.

According to a second aspect of the present invention, in the first aspect of the present invention,

the scanning signal line drive circuit further comprises a clock signal trunk wiring line including a plurality of signal lines that transmit k clock signals as the plurality of clock signals, wherein

each stage of the shift register operates based on the k clock signals.

According to a third aspect of the present invention, in the second aspect of the present invention,

each stage of the shift register includes:
an inter-stage connecting wiring line for receiving a clock signal other than clock signals received from the clock signal trunk wiring line, from a different stage than the stage; and
a contact that electrically connects a wiring line formed on the stage to the inter-stage connecting wiring line, and

in the stages of the shift register, the marks are provided near their respective inter-stage connecting wiring lines.

According to a fourth aspect of the present invention, in the second aspect of the present invention,

each stage of the shift register includes:
an inter-stage connecting wiring line for receiving a clock signal other than clock signals received from the clock signal trunk wiring line, from a different stage than the stage; and
a contact that electrically connects a wiring line formed on the stage to the inter-stage connecting wiring line, and

in the stages of the shift register, the marks are provided near their respective contacts.

According to a fifth aspect of the present invention, in the fourth aspect of the present invention,

positions of the marks with reference to their respective contacts are different for k stages included in each group of the shift register.

According to a sixth aspect of the present invention, in the first aspect of the present invention,

shapes of the marks are different for k stages included in each group of the shift register.

According to a seventh aspect of the present invention, in the first aspect of the present invention,

k stages included in each group of the shift register are provided with different numbers of predetermined structures as the marks, and

the structures are same in number every k stages of the shift register.

According to an eighth aspect of the present invention, in the first aspect of the present invention,

the k is 2 or 4.

According to a ninth aspect of the present invention, in the first aspect of the present invention,

each stage of the shift register includes a thin film transistor, and

each of the marks is formed of a same metal as a metal that forms a gate electrode of the thin film transistor, or a same metal as a metal that forms a source electrode and a drain electrode of the thin film transistor.

According to a tenth aspect of the present invention, in the first aspect of the present invention,

the circuit is formed on a same substrate as the display unit.

An eleventh aspect of the present invention is directed to a display device including the display unit and comprising a scanning signal line drive circuit according to any one of the first to tenth aspect of the present invention.

### Effects of the Invention

According to the first aspect of the present invention, the shift register is grouped every k consecutive stages, and different types of marks are respectively formed on circuits of k stages included in each group such that the same type of mark appears every k stages. Hence, a plurality of stages forming the shift register can be distinguished from one another. By this, shift register testing is facilitated over conventional cases and thus even if a failure occurs in the shift register at a panel fabrication stage, the failure is repaired relatively easily, improving panel yields.

According to the second aspect of the present invention, the shift resister is grouped every some stages, the number of which is equal to the number of clock signals. For (a plurality of) stages to which a plurality of clock signals are provided in the same manner, the same type of marks are formed. Hence, when some kind of failure occurs in the shift register at a panel fabrication stage, it can be easily grasped, based on a mark, how clock signals are provided to a circuit of a stage where the failure has occurred. By this, shift register testing is greatly facilitated over conventional cases and thus even if a failure occurs in the shift register at a panel fabrication stage, the failure is repaired easily, improving panel yields.

According to the third aspect of the present invention, a mark is formed near an inter-stage connecting wire line formation region which is a region not efficiently used because circuit elements are not arranged in a close-packed manner. By this, a region on a substrate is efficiently used for marks, enabling to form a mark on each stage of the shift register without increasing a picture-frame.

According to the fourth aspect of the present invention, a mark is formed near a contact formation region which is a region not efficiently used because circuit elements are not arranged in a close-packed manner. By this, a region on a substrate is efficiently used for marks, enabling to form a mark on each stage of the shift register without increasing a picture-frame.

According to the fifth aspect of the present invention, upon performing shift register testing, etc., it can be grasped, by the position of a mark, how clock signals are provided to a circuit of a stage provided with the mark.

According to the sixth aspect of the present invention, upon performing shift register testing, etc., a plurality of stages forming the shift register can be distinguished from one another by the shapes of marks.

According to the seventh aspect of the present invention, upon performing shift register testing, etc., a plurality of stages forming the shift register can be distinguished from one another by the number of structures forming a mark.

According to the eighth aspect of the present invention, different types of marks are provided for the odd-numbered stages and even-numbered stages of the shift register. By this, a scanning signal line drive circuit is implemented that includes a shift register in which odd-numbered stages and even-numbered stages can be distinguished from each other with a simple configuration.

According to the ninth aspect of the present invention, upon forming electrodes of a thin film transistor on a substrate that forms a panel of a display device, a mark can also be formed on the substrate. By this, a display device is implemented that includes a scanning signal line drive circuit that can obtain the same effects as those obtained in the first aspect of the present invention without unnecessarily increasing the number of fabrication steps.

According to the tenth aspect of the present invention, in a scanning signal line drive circuit formed in a monolithic manner in which failures occur relatively easily in a shift register, a mark is provided on each stage of the shift register. By this, shift register testing is facilitated over conventional cases and thus even if a failure occurs in the shift register at a panel fabrication stage, the failure is repaired relatively easily, significantly improving panel yields.

According to the eleventh aspect of the present invention, a display device is implemented that includes a scanning signal line drive circuit with which the same effect(s) as that obtained in any of the first to tenth aspects of the present invention can be obtained.

### BRIEF DESCRIPTION OF THE DRAWINGS

FIG. 1 is a diagram for describing a layout of markings in a shift register in a gate driver of an active matrix-type liquid crystal display device according to an embodiment of the present invention.

FIG. 2 is a block diagram showing an overall configuration of the liquid crystal display device in the embodiment.

FIG. 3 is a block diagram for describing a configuration of the gate driver in the embodiment.

FIG. 4 is a block diagram showing a configuration of the shift register in the gate driver in the embodiment.

FIG. 5 is a circuit diagram showing a configuration of a bistable circuit included in the shift register in the embodiment.

FIG. 6 is a diagram for describing a layout of the gate driver in the embodiment.

FIG. 7 is a timing chart for describing the operation of the gate driver in the embodiment.

FIG. 8 is a timing chart for describing the operation of the gate driver in the embodiment.

FIG. 9 is a timing chart for describing the operation of a bistable circuit in the embodiment.

FIGS. 10A to 10F are diagrams for describing a method of producing a marking using a metal that forms a gate electrode in the embodiment.

FIGS. 11A to 11G are diagrams for describing a method of producing a marking using a metal that forms a source electrode/drain electrode in the embodiment.

FIG. 12 is a diagram for describing a first variant of the embodiment.

FIG. 13 is a diagram for describing a configuration of contacts.

FIG. 14 is a diagram for describing a layout of markings in a second variant of the embodiment.

FIG. 15 is a diagram for describing a layout of markings in a third variant of the embodiment.

FIG. 16 is a diagram for describing a layout of markings in a fourth variant of the embodiment.

FIG. 17 is a diagram for describing a layout of markings in a fifth variant of the embodiment.

FIG. 18 is a diagram for describing a layout of markings in a sixth variant of the embodiment.

FIG. 19 is a block diagram showing a configuration of a gate driver in which each bistable circuit in a shift register receives all clock signals from trunk wiring lines.

FIG. 20 is a block diagram showing a configuration in which gate drivers are disposed on both sides of a display unit.

FIG. 21 is a circuit diagram showing a configuration of a bistable circuit including a thin film transistor for generating a set signal and a reset signal.

FIG. 22 is a block diagram showing a configuration according to a variant of the configuration of the gate driver shown in FIG. 19.

FIG. 23 is a block diagram showing a configuration according to a variant of the configuration of the gate driver shown in FIG. 20.

### MODE FOR CARRYING OUT THE INVENTION

An embodiment of the present invention will be described below with reference to the accompanying drawings.

<1. Overall Configuration and Operation>

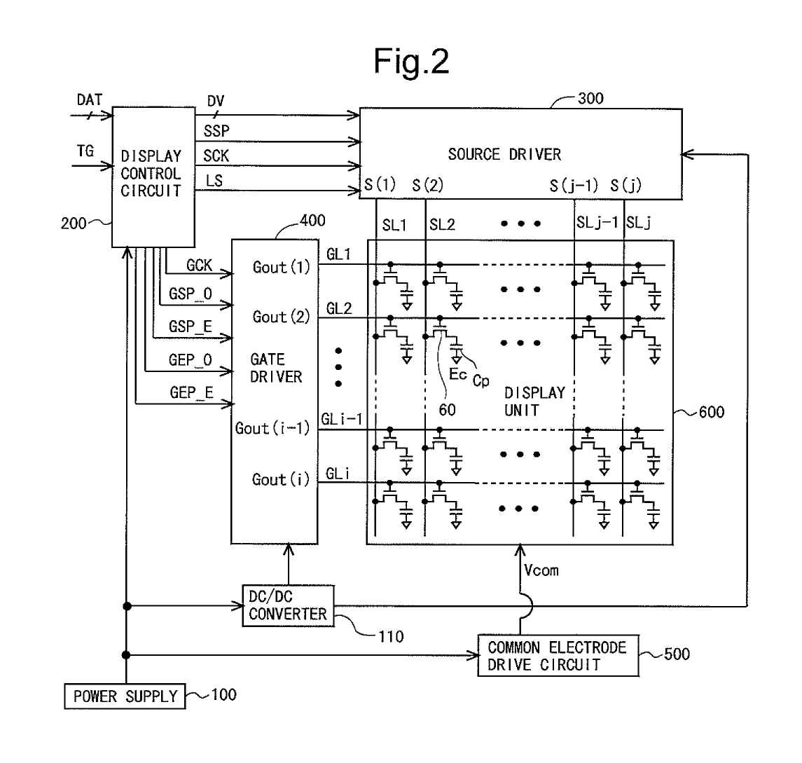

FIG. 2 is a block diagram showing an overall configuration of an active matrix-type liquid crystal display device according to an embodiment of the present invention. As shown in FIG. 2, the liquid crystal display device includes a power supply 100, a DC/DC converter 110, a display control circuit 200, a source driver (video signal line drive circuit) 300, a gate driver (scanning signal line drive circuit) 400, a common electrode drive circuit 500, and a display unit 600. Note that in the present embodiment the gate driver 400 and the display unit 600 are formed on the same substrate. Namely, the gate driver 400 in the present embodiment is a “monolithic gate driver”.

The display unit 600 includes a plurality of (j) source bus lines (video signal lines) SL1 to SLj; a plurality of (i) gate bus lines (scanning signal lines) GL1 to GLi; and a plurality of (i×j) pixel formation portions provided at the respective intersections of the source bus lines SL1 to SLj and the gate bus lines GL1 to GLi. Note that in the following i=2a.

The plurality of pixel formation portions are arranged in a matrix form and thereby form a pixel array. Each pixel formation portion is composed of a thin film transistor (TFT) 60 which is a switching element connected at its gate terminal to a gate bus line passing through a corresponding intersection, and connected at its source terminal to a source bus line passing through the intersection; a pixel electrode connected to the drain terminal of the thin film transistor 60; a common electrode Ec which is a counter electrode provided so as to be shared by the plurality of pixel formation portions; and a liquid crystal layer which is provided so as to be shared by the plurality of pixel formation portions and which is sandwiched between the pixel electrode and the common electrode Ec. By a liquid crystal capacitance formed by the pixel electrode and the common electrode Ec, a pixel capacitance Cp is formed. Note that normally, an auxiliary capacitance is provided in parallel with the liquid crystal capacitance in order to securely hold a voltage in the pixel capacitance Cp; however, the auxiliary capacitance is not directly related to the present invention and thus the description and depiction thereof are omitted.

The power supply 100 supplies a predetermined power supply voltage to the DC/DC converter 110, the display control circuit 200, and the common electrode drive circuit 500. The DC/DC converter 110 generates a predetermined direct-current voltage for operating the source driver 300 and the gate driver 400, from the power supply voltage and supplies the direct-current voltage to the source driver 300 and the gate driver 400. The common electrode drive circuit 500 provides a predetermined potential Vcom to the common electrode Ec.

The display control circuit 200 receives an image signal DAT and a timing signal group TG such as a horizontal synchronizing signal and a vertical synchronizing signal which are sent from an external source, and outputs a digital video signal DV and a source start pulse signal SSP, a source clock signal SCK, a latch strobe signal LS, a first gate start pulse signal GSP_O, a second gate start pulse signal GSP_E, a first gate end pulse signal GEP_O, a second gate end pulse signal GEP_E, and a gate clock signal GCK which are for controlling image display on the display unit 600. Note that in the present embodiment the gate clock signal GCK includes 4-phase clock signals CK1 (hereinafter, referred to as a “first gate clock signal”), CK1B (hereinafter, referred to as a “secondgate clock signal”), CK2 (hereinafter, referred to as a “third gate clock signal”), and CK2B (hereinafter, referred to as a “fourth gate clock signal”).

The source driver 300 receives the digital video signal DV, the source start pulse signal SSP, the source clock signal SCK, and the latch strobe signal LS which are outputted from the display control circuit 200, and applies driving video signals S(1) to S(j) to the source bus lines SL1 to SLj, respectively.

The gate driver 400 repeats application of active scanning signals Gout(1) to Gout(i) to the respective gate bus lines GL1 to GLi in cycles of one vertical scanning period, based on the first gate start pulse signal GSP_O, the second gate start pulse signal GSP_E, the first gate end pulse signal GEP_O, the second gate end pulse signal GEP_E, and the gate clock signal GCK which are outputted from the display control circuit 200. Note that a detailed description of the gate driver 400 will be made later.

In the above-described manner, the driving video signals S(1) to S(j) are applied to the source bus lines SL1 to SLj, respectively, and the scanning signals Gout(1) to Gout(i) are applied to the gate bus lines GL1 to GLi, respectively, whereby an image based on the image signal DAT which is sent from the external source is displayed on the display unit 600.

<2. Configuration of the Gate Driver>

<2.1 Schematic Configuration of the Gate Driver>

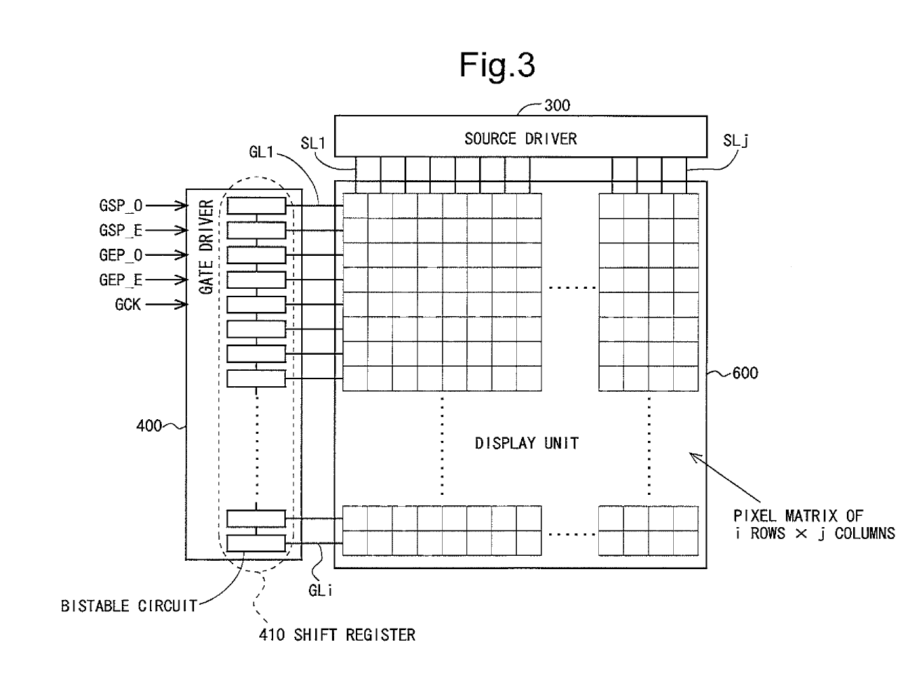

Next, a configuration of the gate driver 400 in the present embodiment will be described. As shown in FIG. 3, the gate driver 400 is composed of a shift register 410 of a plurality of stages. A pixel matrix of i rows×j columns is formed in the display unit 600, and the stages of the shift register 410 are provided so as to have a one-to-one correspondence with the rows of the pixel matrix. In addition, each stage of the shift register 410 is a bistable circuit which is in either one of two states (a first state and a second state) at each time point and outputs a signal indicating the state (hereinafter, referred to as a “state signal”). As such, the shift register 410 is composed of i(=2a) bistable circuits.

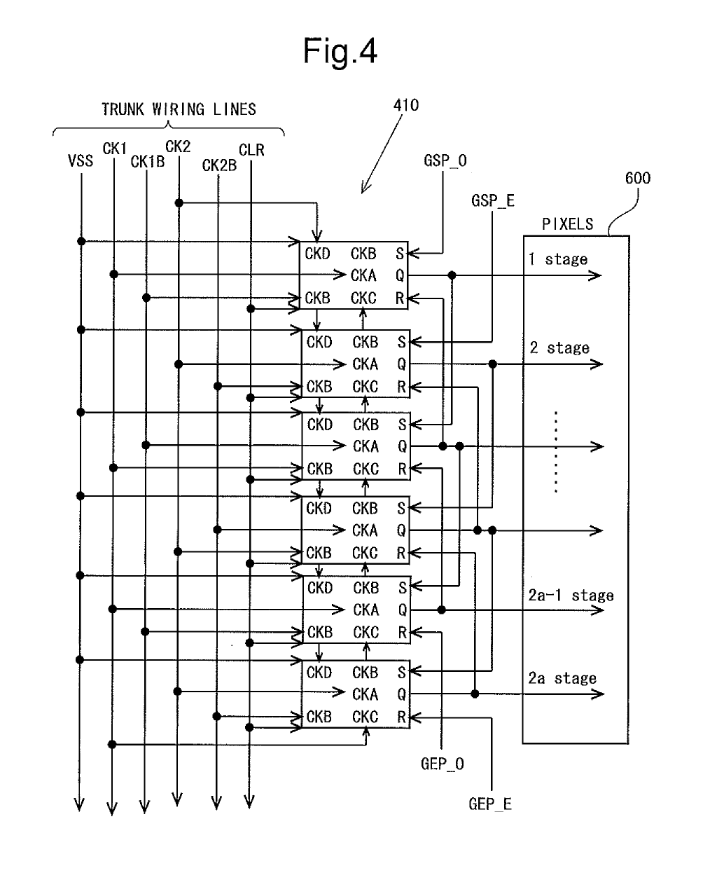

FIG. 4 is a block diagram showing a configuration of the shift register 410 in the gate driver 400. As described above, the shift register 410 is composed of 2a bistable circuits. Each bistable circuit is provided with input terminals for receiving 4-phase clock signals CKA (hereinafter, referred to as a “first clock”), CKB (hereinafter, referred to as a “second clock”), CKC (hereinafter, referred to as a “third clock”), and CKD (hereinafter, referred to as a “fourth clock”); an input terminal for receiving a set signal S; an input terminal for receiving a reset signal R; an input terminal for receiving a clear signal CLR; an input terminal for receiving a low-potential direct-current voltage VSS; and an output terminal for outputting a state signal Q.

In FIG. 4, trunk wiring lines for a gate clock signal GCK (a first gate clock signal CK1, a second gate clock signal CK1B, a third gate clock signal CK2, and a fourth gate clock signal CK2B), a trunk wiring line for a low-potential direct-current voltage VSS, and a trunk wiring line for a clear signal CLR are formed on the left of a region where the 2a bistable circuits are formed. Namely, these trunk wiring lines are arranged in a region on the opposite side of the display unit 600 with respect to the shift register 410.

<2.2 Configuration of the Bistable Circuits>

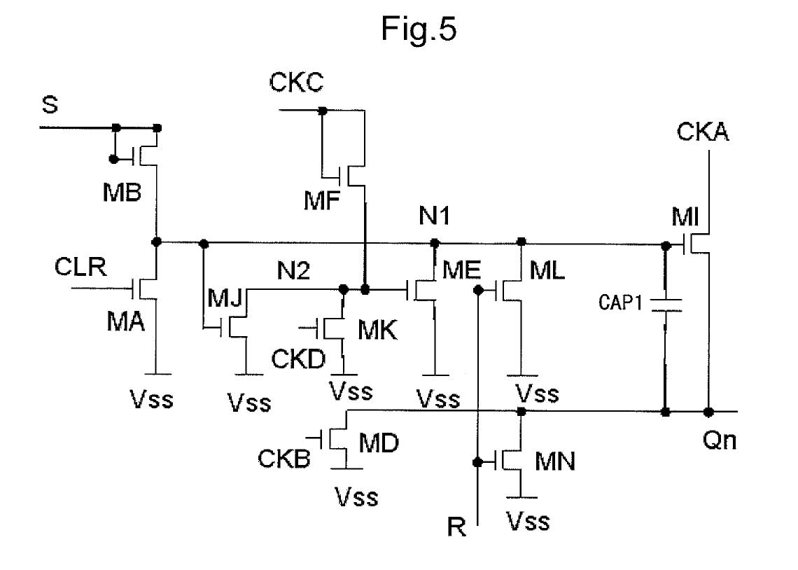

FIG. 5 is a circuit diagram showing a configuration of a bistable circuit included in the shift register 410 (a configuration for one stage of the shift register 410). As shown in FIG. 5, the bistable circuit includes 10 thin film transistors MA, MB, MI, MF, MJ, MK, ME, ML, MN, and MD and a capacitor CAP1. In addition, the bistable circuit includes an input terminal that receives a first clock CKA; an input terminal that receives a second clock CKB; an input terminal that receives a third clock CKC; an input terminal that receives a fourth clock CKD; an input terminal that receives a set signal S; an input terminal that receives a reset signal R; an input terminal that receives a clear signal CLR; and an output terminal that outputs a state signal Qn.

The source terminal of the thin film transistor MB, the drain terminal of the thin film transistor MA, the gate terminal of the thin film transistor MJ, the drain terminal of the thin film transistor ME, the drain terminal of the thin film transistor ML, the gate terminal of the thin film transistor MI, and one end of the capacitor CAP1 are connected to one another. Note that a region (wiring line) where they are connected to one another is referred to as a “first node” for convenience's sake and is given reference character N1.

The drain terminal of the thin film transistor MJ, the drain terminal of the thin film transistor MK, the source terminal of the thin film transistor MF, and the gate terminal of the think film transistor ME are connected to one another. Note that a region (wiring line) where they are connected to one another is referred to as a “second node” for convenience's sake and is given reference character N2.

Next, the functions of the respective components in the bistable circuit will be described. The thin film transistor MA brings the potential of the first node N1 to a low level when the clear signal is at a high level. The thin film transistor MB brings the potential of the first node N1 to a high level when the set signal S is at a high level. The thin film transistor MI provides the potential of the first clock CKA to the output terminal when the potential of the first node N1 is at a high level. The thin film transistor MF brings the potential of the second node N2 to a high level when the third clock CKC is at a high level.

The thin film transistor MJ brings the potential of the second node N2 to a low level when the potential of the first node N1 is at a high level. If, during a period during which a gate bus line connected to the output terminal of the bistable circuit is selected (hereinafter, referred to as a “selected period”), the second node N2 goes to a high level and thus the thin film transistor ME is placed in an on state, then the potential of the first node N1 decreases and thus the thin film transistor MI is placed in an off state. To prevent such a phenomenon, the thin film transistor MJ is provided.

The thin film transistor MK brings the potential of the second node N2 to a low level when the fourth clock CKD is at a high level. If the thin film transistor MK is not provided, then during periods other than a selected period, the potential of the second node N2 is always at a high level and thus a bias voltage is continuously applied to the thin film transistor ME. This in turn increases the threshold voltage of the thin film transistor ME and accordingly the thin film transistor ME does not sufficiently function as a switch. To prevent such a phenomenon, the thin film transistor MK is provided.

The thin film transistor ME brings the potential of the first node N1 to a low level when the potential of the second node N2 is at a high level. The thin film transistor ML brings the potential of the first node N1 to a low level when the reset signal R is at a high level. The thin film transistor MN brings the potential of the output terminal to a low level when the reset signal R is at a high level. The thin film transistor MD brings the potential of the output terminal to a low level when the second clock CKB is at a high level. The capacitor CAP1 functions as a compensation capacitance for maintaining the potential of the first node N1 at a high level during a period during which the gate bus line connected to the output terminal of the bistable circuit is selected.

<2.3 Layout of the Gate Driver>

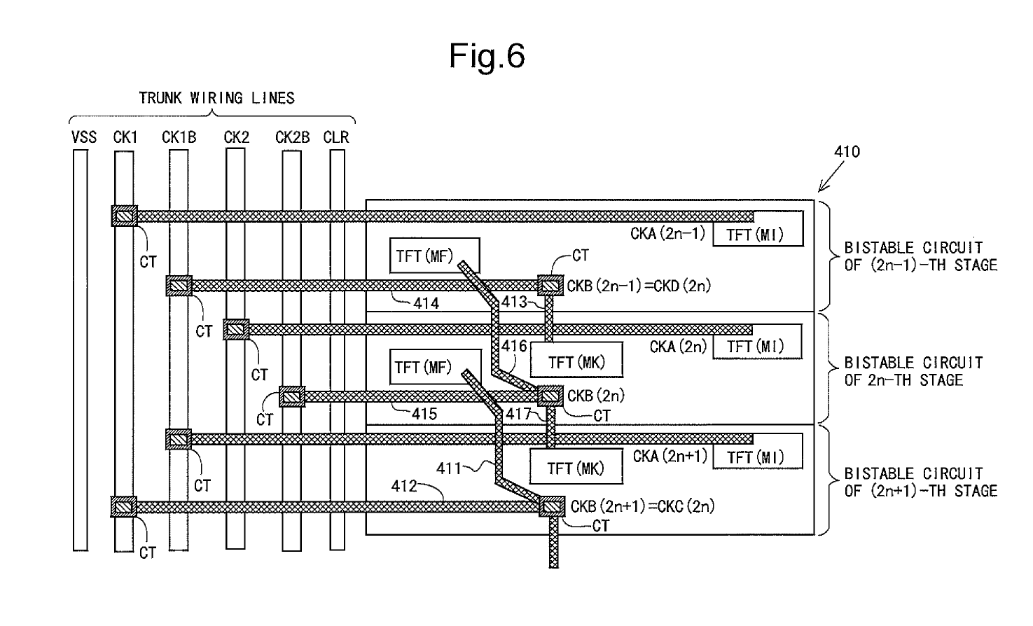

FIG. 6 is a diagram for describing a layout of the gate driver 400 in the present embodiment. In FIG. 6, when taking a look at a bistable circuit of the 2nth-stage (n is a positive integer), of four clock signals provided to the bistable circuit, a first clock CKA and a second clock CKB are provided from trunk wiring lines for clock signals, a third clock CKC to be provided to a thin film transistor MF is provided from a bistable circuit of the (2n+1)-th stage, and a fourth clock CKD to be provided to a thin film transistor MK is provided from a bistable circuit of the (2n−1)-th stage. To do so, a wiring line 411 for providing a third clock CKC to the thin film transistor MF in the bistable circuit of the 2n-th stage is connected, through a contact CT in the bistable circuit of the (2n+1)-th stage, to a wiring line 412 for providing a second clock CKB to the bistable circuit of the (2n+1)-th stage from a trunk wiring line. In addition, a wiring line 413 for providing a fourth clock CKD to the thin film transistor MK in the bistable circuit of the 2n-th stage is connected, through a contact CT in the bistable circuit of the (2n−1)-th stage, to a wiring line 414 for providing a second clock CKB to the bistable circuit of the (2n−1)-th stage from a trunk wiring line.

Furthermore, a wiring line 415 for providing a second clock CKB to the bistable circuit of the 2n-th stage from the trunk wiring line, a wiring line 416 for providing the second clock CKB in the bistable circuit of the 2n-th stage to a thin film transistor MF in the bistable circuit of the (2n−1)-th stage as a third clock CKC in the bistable circuit of the (2n−1)-th stage, and a wiring line 417 for providing the second clock CKB in the bistable circuit of the 2n-th stage to a thin film transistor MK in the bistable circuit of the (2n+1)-th stage as a fourth clock CKD in the bistable circuit of the (2n+1)-th stage are connected to one another through a contact CT in the bistable circuit of the 2n-th stage. Note that, in the following, wiring lines that connect different stages (bistable circuits) of the shift register 410 such as the wiring lines 411, 413, 416, and 417 in FIG. 6 are referred to as “inter-stage connecting wiring lines”.

As described above, in the present embodiment, the configuration is such that, of four clock signals provided to each bistable circuit, only a first clock CKA and a second clock CKB are provided from the trunk wiring lines and a third clock CKC and a fourth clock CKD are provided from a subsequent stage or a previous stage through an inter-stage connecting wiring line. Note, however, that as shown in FIG. 4, in the present embodiment, for a bistable circuit of the first stage a fourth clock CKD is also provided from a trunk wiring line, and for a bistable circuit of the i-th stage (i=2a) a third clock CKC is also provided from a trunk wiring line.

<3. Operations of the Gate Driver and the Bistable Circuits>

With reference to FIGS. 4, 7, and 8, the operation of the gate driver 400 in the present embodiment will be described. To the shift register 410 are provided 4-phase clock signals (a first gate clock signal CK1, a second gate clock signal CK1B, a third gate clock signal CK2, and a fourth gate clock signal CK2B), a first gate start pulse signal GSP_O, a second gate start pulse signal GSP_E, a first gate end pulse signal GEP_O, a second gate end pulse signal GEP_E, a low-potential direct-current voltage VSS, and a clear signal CLR.

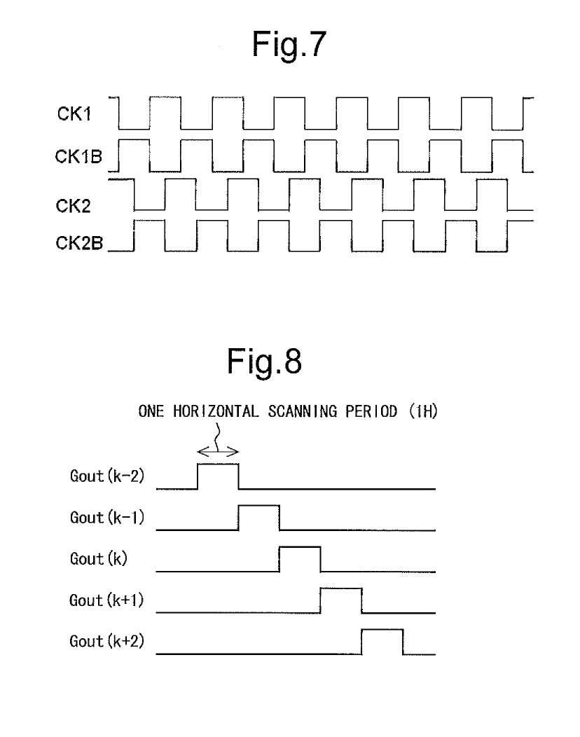

As shown in FIG. 7, the first gate clock signal CK1 and the second gate clock signal CK1B are shifted in phase by 180 degrees (a period corresponding to one horizontal scanning period) and the third gate clock signal CK2 and the fourth gate clock signal CK2B are shifted in phase by 180 degrees. In addition, the third gate clock signal CK2 is delayed in phase by 90 degrees from the first gate clock signal CK1. The first to fourth gate clock signals CK1, CK1B, CK2, and CK2B are all placed in a high level (H level) state every other horizontal scanning period.

Signals to be provided to the input terminals of each stage (each bistable circuit) of the shift register 410 are as follows. The low-potential direct-current voltage VSS and the clear signal CLR are provided to all of the stages in a sharing manner. For the first stage, the first gate clock signal CK1 is provided as a first clock CKA, the second gate clock signal CK1B is provided as a second clock CKB, a second clock CKB outputted from the second stage is provided as a third clock CKC, and the third gate clock signal CK2 is provided as a fourth clock CKD. For the second stage, the third gate clock signal CK2 is provided as a first clock CKA, the fourth gate clock signal CK2B is provided as a second clock CKB, a second clock CKB outputted from the third stage is provided as a third clock CKC, and the second clock CKB outputted from the first stage is provided as a fourth clock CKD. For the third stage, the second gate clock signal CK1B is provided as a first clock CKA, the first gate clock signal CK1 is provided as a second clock CKB, a second clock signal CKB outputted from the fourth stage is provided as a third clock CKC, and the second clock signal CKB outputted from the second stage is provided as a fourth clock CKD. For the fourth stage, the fourth gate clock signal CK2B is provided as a first clock CKA, the third gate clock signal CK2 is provided as a second clock CKB, a second clock CKB outputted from the fifth stage is provided as a third clock CKC, and the second clock signal CKB outputted from the third stage is provided as a fourth clock CKD. For the fifth stage, the first gate clock signal CK1 is provided as a first clock CKA, the second gate clock signal CK1B is provided as a second clock CKB, a second clock CKB outputted from the sixth stage is provided as a third clock CKC, and the second clock signal CKB outputted from the fourth stage is provided as a fourth clock CKD. For the sixth stage to the (2a−1)-th stage, the same configuration as that of the above-described second to fifth stages is repeated every four stages. For the 2a-th stage, the third gate clock signal CK2 is provided as a first clock CKA, the fourth gate clock signal CK2B is provided as a second clock CKB, the first gate clock signal CK1 is provided as a third clock CKC, and the second clock CKB outputted from the (2a−1)-th stage is provided as a fourth clock CKD.

In addition, to the first stage, the first gate start pulse signal GSP_O is provided as a set signal S, and a state signal Q outputted from the third stage is provided as a reset signal R. To the second stage, the second gate start pulse signal GSP_E is provided as a set signal S, and a state signal Q outputted from the fourth stage is provided as a reset signal R. To the third to (2a−2)-th stages, a state signal Q outputted from a stage immediately before the previous stage is provided as a set signal S, and a state signal Q outputted from a stage immediately after the subsequent stage is provided as a reset signal R. To the (2a−1)-th stage, a stage signal Q outputted from the (2a−3)-th stage is provided as a set signal S, and the first gate end pulse signal GEP_O is provided as a reset signal R. To the 2a-th stage, a stage signal Q outputted from the (2a−2)-th stage is provided as a set signal S, and the second gate end pulse signal GEP_E is provided as a reset signal R.

A first gate start pulse signal GSP_O serving as a set signal S is provided to the first stage of the shift register 410 and a second gate start pulse signal GSP_E serving as a set signal S is provided to the second stage, and a pulse included in the first gate start pulse signal GSP_O or the second gate start pulse signal GSP_E (this pulse is included in a state signal Q outputted from each stage) is sequentially transferred from the first stage to the 2a-th stage based on the first to fourth gate clock signals CK1, CK1B, CK2, and CK2B. Then, according to the transfer of the pulse, the stage signal Q outputted from each stage sequentially goes to a high level. Then, the state signals Q outputted from the respective stages are provided to the gate bus lines GL1 to GLi, respectively, as scanning signals Gout(1) to Gout(i). By this, as shown in FIG. 8, scanning signals which sequentially go to a high level every horizontal scanning period are provided to the gate bus lines in the display unit 600.

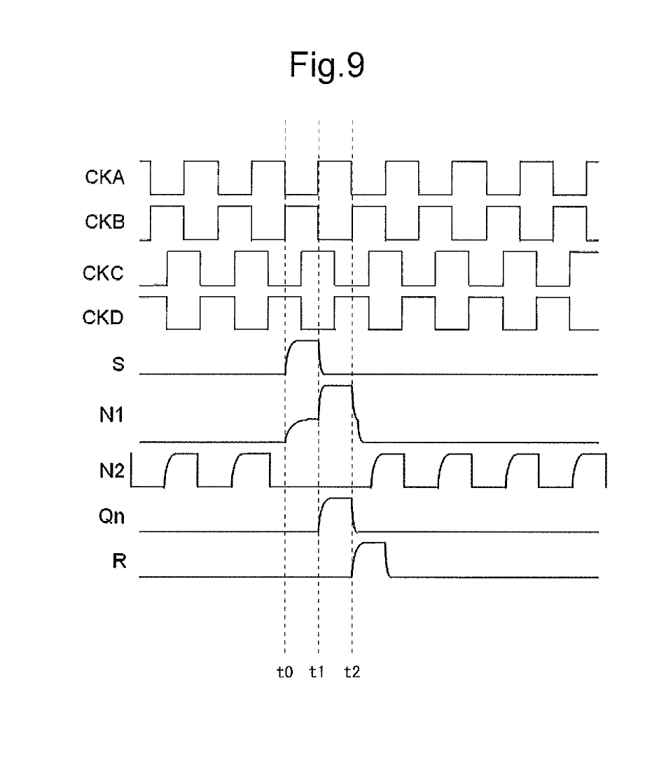

With reference to FIGS. 5 and 9, the operation of a bistable circuit in the present embodiment will be described. During the operation of the liquid crystal display device, first to fourth clocks CKA to CKD having waveforms such as those shown in FIG. 9 are provided to a bistable circuit. At time point t0, a pulse of a set signal S is provided to the bistable circuit. Since the thin film transistor MB is diode-connected, the first node N1 is precharged by the pulse of the set signal S during the period from t0 to t1. During this period, the thin film transistor MJ is placed in an on state, and thus, the potential of the second node N2 is brought to a low level. In addition, during this period, a reset signal R is at a low level. By the above, the thin film transistor ME and the thin film transistor ML are placed in an off state and thus the potential of the first node N1 having increased by the precharge does not decrease during the period from t0 to t1.

When reaching time point t1, the first clock CKA changes from a low level to a high level. Note that the first clock CKA is provided to the bistable circuit from a trunk wiring line. Here, the first clock CKA is provided to the source terminal of the thin film transistor MI, and a parasitic capacitance (not shown) is present between the gate and source of the thin film transistor MI. Hence, according to an increase in the source potential of the thin film transistor MI, the potential of the first node N1 also increases (the first node N1 is boot-strapped). As a result, the thin film transistor MI is placed in an on state. Since the state in which the first clock CKA is brought to a high level is maintained until time point t2, a state signal Qn is at a high level during the period from t1 to t2. By this, a gate bus line connected to the bistable circuit that outputs the high-level state signal Qn is placed in a selected state, and thus, writing of video signals to pixel capacitances Cp is performed in pixel formation portions of a row corresponding to the gate bus line. Note that during the period from t1 to t2, as with the period from t0 to t1, the thin film transistor ME and the thin film transistor ML are placed in an off state. Hence, during the period from t1 to t2, the potential of the first node N1 does not decrease.

When reaching time point t2, the first clock CKA changes from a high level to a low level. In addition, the second clock CKB changes from a low level to a high level. Note that the first clock CKA and the second clock CKB are provided to the bistable circuit from trunk wiring lines. Furthermore, the reset signal R changes from a low level to a high level. By this, the thin film transistors MD, ML, and MN are placed in an on state. By the thin film transistor MD and the thin film transistor MN being placed in an on state, the potential of the state signal Qn decreases to a low level. In addition, by the thin film transistor ML being placed in an on state, the potential of the first node N1 decreases to a low level.

<4. For Markings (Marks) on the Bistable Circuits>

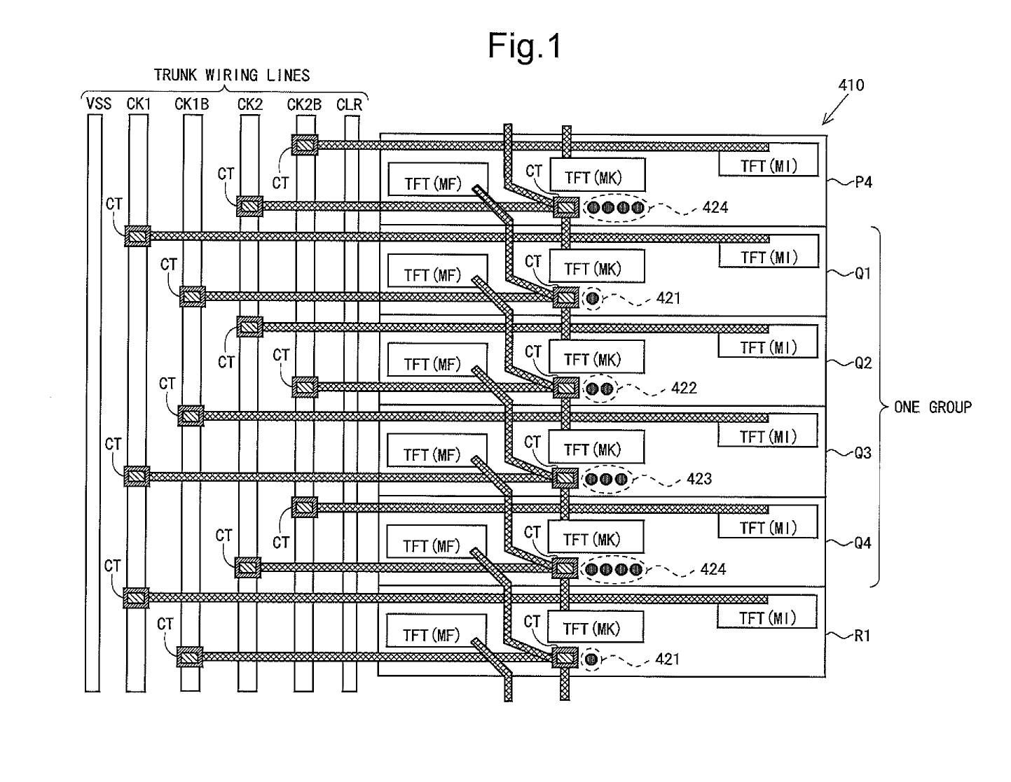

In the present embodiment, a marking (mark) is provided on each of the bistable circuits composing the shift register 410. This will be described with reference to FIG. 1. As described above, the shift register 410 in the present embodiment operates based on 4-phase clock signals. In addition, a gate clock signal GCK provided to each stage (each bistable circuit) of the shift register 410 as a first clock CKA is a first gate clock signal CK1 for the first stage, is a third gate clock signal CK2 for the second stage, is a second gate clock signal CK1B for the third stage, and is a fourth gate clock signal CK2B for the fourth stage. For the fifth and subsequent stages, the same clock signals as those for the first to fourth stages are provided to the respective stages every four stages. In this manner, during a period corresponding to one cycle of the gate clock signal GCK, four gate bus lines connected to the respective output terminals of consecutive bistable circuits of four stages are sequentially selected one by one. Hence, in the present embodiment, four bistable circuits consecutively arranged in the shift register 410 are treated as one group.

When taking a look at a group including four bistable circuits denoted by reference characters Q1 to Q4 in FIG. 1, a marking 421 formed of a single planar-view circular-shaped structure is formed on the bistable circuit Q1, a marking 422 formed of two planar-view circular-shaped structures is formed on the bistable circuit Q2, a marking 423 formed of three planar-view circular-shaped structures is formed on the bistable circuit Q3, and a marking 424 formed of four planar-view circular-shaped structures is formed on the bistable circuit Q4. Note that the markings 421 to 424 are formed near their respective contacts CT of the bistable circuits Q1 to Q4. For bistable circuits of those stages before the bistable circuit Q1 and bistable circuits of those stages after the bistable circuit Q4, too, the same markings are provided on the respective bistable circuits. Specifically, a marking 421 formed of a single planar-view circular-shaped structure is formed on the first stage in each group, a marking 422 formed of two planar-view circular-shaped structures is formed on the second stage in each group, a marking 423 formed of three planar-view circular-shaped structures is formed on the third stage in each group, and a marking 424 formed of four planar-view circular-shaped structures is formed on the fourth stage in each group.

Next, a method of producing the aforementioned markings will be described. In the present embodiment, a marking is implemented by a metal that forms a gate electrode or a source electrode/drain electrode of a thin film transistor. Hence, in the following, a procedure for when it is assumed to form a marking formed of three structures on a glass substrate will be described.

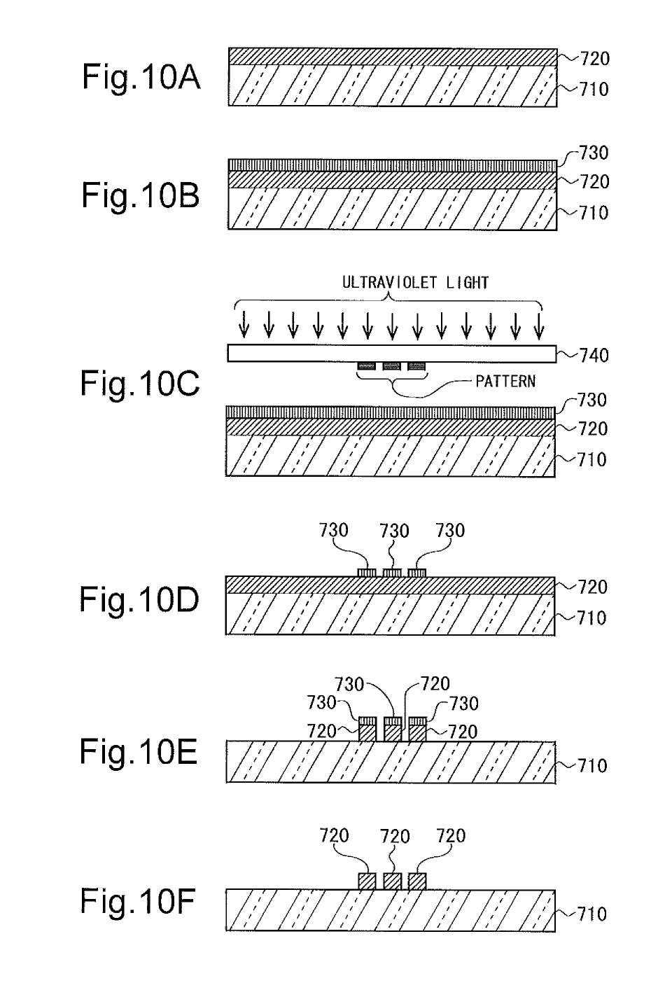

First, a procedure for the case of forming a marking using a metal that forms a gate electrode will be described. First, as shown in FIG. 10A, a metal film 720 using, as its material, chromium (Cr), molybdenum (Mo), tantalum (Ta), titanium (Ti), aluminum (Al), etc., is formed on a glass substrate 710 by a sputtering method. Then, as shown in FIG. 10B, a UV-sensitive resist 730 is applied onto the metal film 720. Then, the resist 730 is baked at a high temperature and is thereby hardened. Then, as shown in FIG. 10C, ultraviolet light is irradiated onto the glass substrate 710 through a mask 740 where a pattern corresponding to a marking is drawn. By this, a portion of the resist 730 corresponding to an area where the pattern is not drawn is softened. Then, by development, as shown in FIG. 10D, the softened resist 730 is removed. Then, again, the resist 730 is baked at a high temperature and is thereby hardened. Then, by performing wet etching or dry etching, as shown in FIG. 10E, an unnecessary portion of the metal film 720 is removed. Thereafter, as shown in FIG. 10F, the resist 730 is peeled off using a peeling solution. In the above-described manner, a marking formed of a metal that forms a gate electrode is formed on the glass substrate 710.

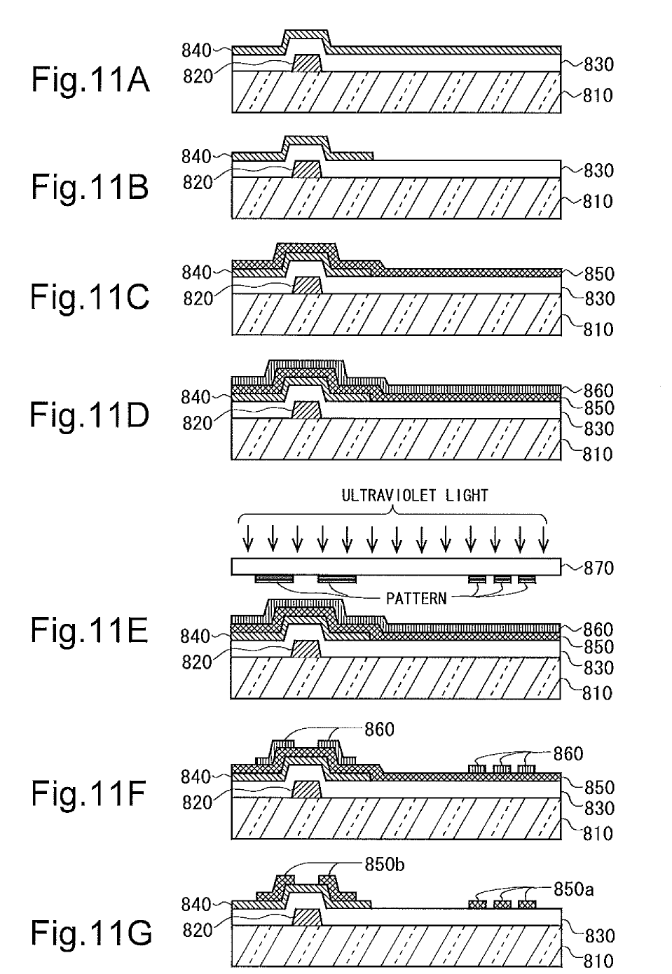

Next, a procedure for the case of forming a marking using a metal that forms a source electrode/drain electrode will be described. Note that here it is assumed that, as shown in FIG. 11A, a gate electrode 820, a gate insulating film 830, and a semiconductor layer 840 are already stacked on top of one another on a glass substrate 810. After obtaining the substrate in a state shown in FIG. 11A, a predetermined portion of the semiconductor layer 840 that includes a region where a marking is to be formed is removed by the same technique (photolithography method) as that shown in FIGS. 10B to 10F. By this, the substrate in a state shown in FIG. 11B is obtained. Thereafter, as shown in FIG. 11C, a metal film 850 using, as its material, chromium (Cr), molybdenum (Mo), tantalum (Ta), titanium (Ti), aluminum (Al), etc., is formed on the gate insulating film 830 and the semiconductor layer 840 by a sputtering method. Then, as shown in FIG. 11D, a UV-sensitive resist 860 is applied onto the metal film 850. Then, the resist 860 is baked at a high temperature and is thereby hardened. Then, as shown in FIG. 11E, ultraviolet light is irradiated onto the glass substrate 810 through a mask 870 where a pattern corresponding to a source electrode/drain electrode and a pattern corresponding to a marking are drawn. By this, a portion of the resist 860 corresponding to an area where the patterns are not drawn is softened. Then, by development, as shown in FIG. 11F, the softened resist 860 is removed. Then, again, the resist 860 is baked at a high temperature and is thereby hardened. Then, by performing wet etching or dry etching, an unnecessary portion of the metal film 850 is removed. Thereafter, the resist 860 is peeled off by using a peeling solution. By this, as shown in FIG. 11G, a marking formed of a metal that forms a source electrode/drain electrode is formed on the glass substrate 810. Note that in FIG. 11G the marking is denoted by reference character 850a and the source electrode/drain electrode are denoted by reference character 850b.

<5. Effects>

According to the present embodiment, the markings 421 to 424 are provided on the bistable circuits composing the shift register 410 in the gate driver 400. Specifically, the shift register 410 in the present embodiment operates based on 4-phase clock signals, and the bistable circuits in the shift register 410 are grouped every four stages, and markings formed of different numbers of planar-view circular-shaped structures are formed on bistable circuits of four stages included in each group such that the same type of marking appears every four stages. Hence, when some kind of failure occurs in the shift register 410 at a panel fabrication stage, it can be easily grasped, for example, how four clock signals are provided to a bistable circuit where the failure has occurred. As such, shift register testing is facilitated over conventional cases. As a result, even if a failure occurs in the shift register 410 at a panel fabrication stage, the failure is repaired relatively easily, improving panel yields.

Meanwhile, in many cases, circuit elements are not arranged in a close-packed manner near a contact CT that electrically connects a wiring line for providing a clock signal to a bistable circuit from a trunk wiring line, to an inter-stage connecting wiring line and thus a region on a substrate is not efficiently used. In this regard, according to the present embodiment, as shown in FIG. 1, the markings 421 to 424 are formed near the contacts CT of the respective bistable circuits. By this, the region on the substrate is efficiently used by planar-view circular-shaped structures that form the markings 421 to 424 and thus a marking is formed on each stage of the shift register 410 without increasing a picture-frame.

<6. Variants>

Various variants of the above-described embodiment will be described below.

<6.1 For the Shape of the Markings>

<6.1.1 First Variant>

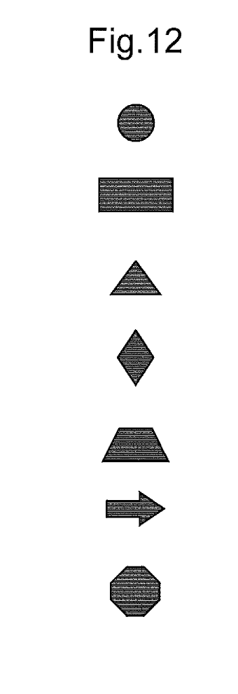

Although in the above-described embodiment, for the shape of a structure (s) forming a marking, a circular shape is adopted, the present invention is not limited thereto. A marking may be formed by a structure(s) having shapes such as those illustrated in FIG. 12 when viewed in planar fashion. Namely, the shape of a marking is not limited in any way.

<6.2 For the Configuration of the Contacts>

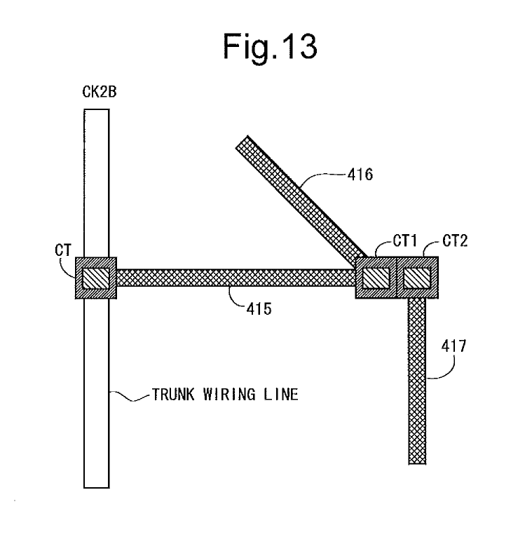

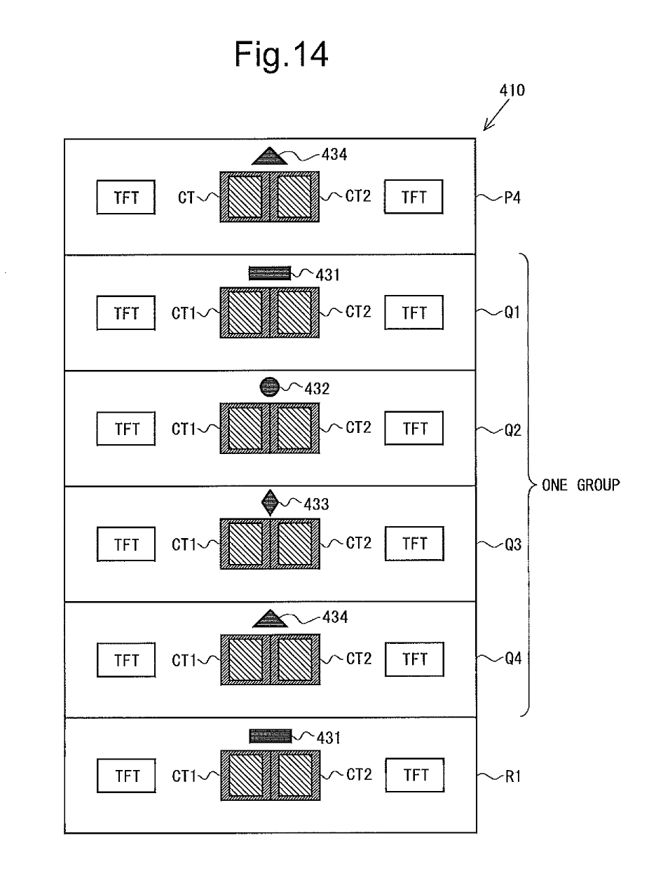

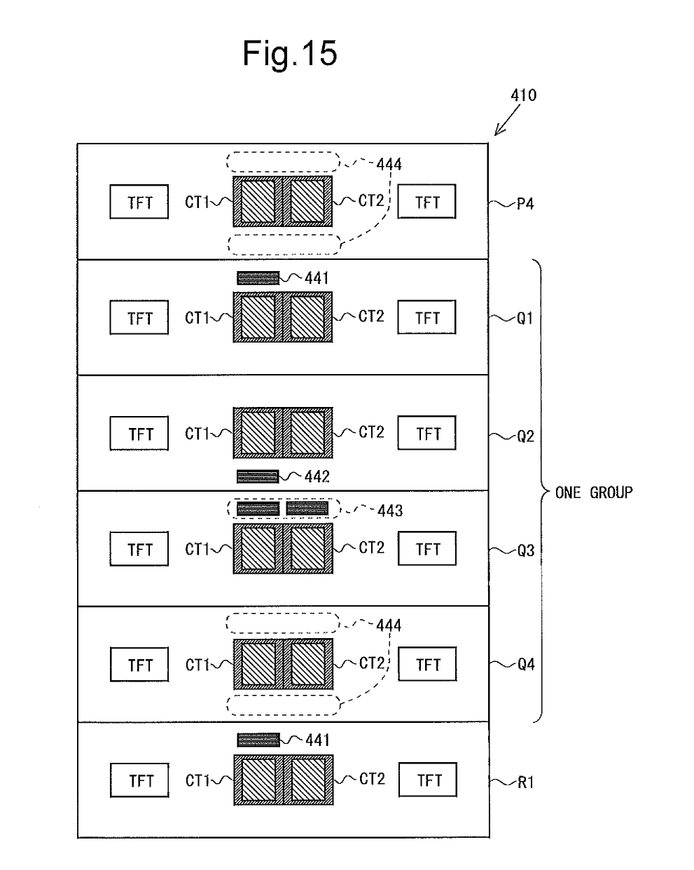

In the above-described embodiment, when taking a look at the bistable circuit of the 2n-th stage in FIG. 6, a contact for connecting the wiring line 415 for providing a second clock CKB to the bistable circuit of the 2n-th stage from a trunk wiring line to the wiring line 416 for providing the second clock CKB in the bistable circuit of the 2n-th stage to the bistable circuit of the (2n−1)-th stage as a third clock CKC, and a contact for connecting the wiring line 415 for providing the second clock CKB to the bistable circuit of the 2n-th stage from the trunk wiring line to the wiring line 417 for providing the second clock CKB in the bistable circuit of the 2n-th stage to the bistable circuit of the (2n+1)-th stage as a fourth clock CKD are implemented by a single contact CT. However, the configuration may be such that, as shown in FIG. 13, a contact CT1 for connecting a wiring line 415 to a wiring line 416 and a contact CT2 for connecting the wiring line 415 to a wiring line 417 are different contacts, and the contacts CT1 and CT2 are arranged adjacent to each other so as to be electrically connected to each other. In a shift register 410 composed of a plurality of bistable circuits including contacts CT1 and CT2 having such a configuration, the above-described markings may be formed as shown in, for example, FIGS. 14 and 15. Note that in FIGS. 14 and 15, inter-stage connecting wiring lines are omitted.

<6.2.1 Second Variant>

FIG. 14 is a diagram for describing a layout of markings in a second variant of the above-described embodiment. In the present variant, markings are formed by structures of different shapes for bistable circuits of four stages included in each group. Specifically, a marking 431 formed of a planar-view rectangular-shaped structure is formed on the first stage in each group, a marking 432 formed of a planar-view circular-shaped structure is formed on the second stage in each group, a marking 433 formed of a planar-view rhombic-shaped structure is formed on the third stage in each group, and a marking 434 formed of a planar-view triangular-shaped structure is formed on the fourth stage in each group. Note that for the shapes of these structures, various shapes such as the shapes shown in FIG. 12 can be adopted.

<6.2.2 Third Variant>

FIG. 15 is a diagram for describing a layout of markings in a third variant of the above-described embodiment. In the present variant, a marking is implemented according to the disposed position of a planar-view rectangular-shaped structure with reference to contacts CT1 and CT2 and the number of planar-view rectangular-shaped structures provided near the contacts CT1 and CT2. Specifically, for the first stage in each group, a marking 441 is implemented by a single planar-view rectangular-shaped structure provided above a contact CT1 when viewed in planar fashion; for the second stage in each group, a marking 442 is implemented by a single planar-view rectangular-shaped structure provided below a contact CT1 when viewed in planar fashion; and for the third stage in each group, a marking 443 is implemented by two planar-view rectangular-shaped structures provided above contacts CT1 and CT2 when viewed in planar fashion. Meanwhile, for the fourth stage in each group, no planar-view rectangular-shaped structure is provided. Namely, for the fourth stage in each group, a marking 444 is that there is not even a single planar-view rectangular-shaped structure provided near contacts CT1 and CT2.

<6.3 For the Configuration of the Inter-Stage Connecting Wiring Lines>

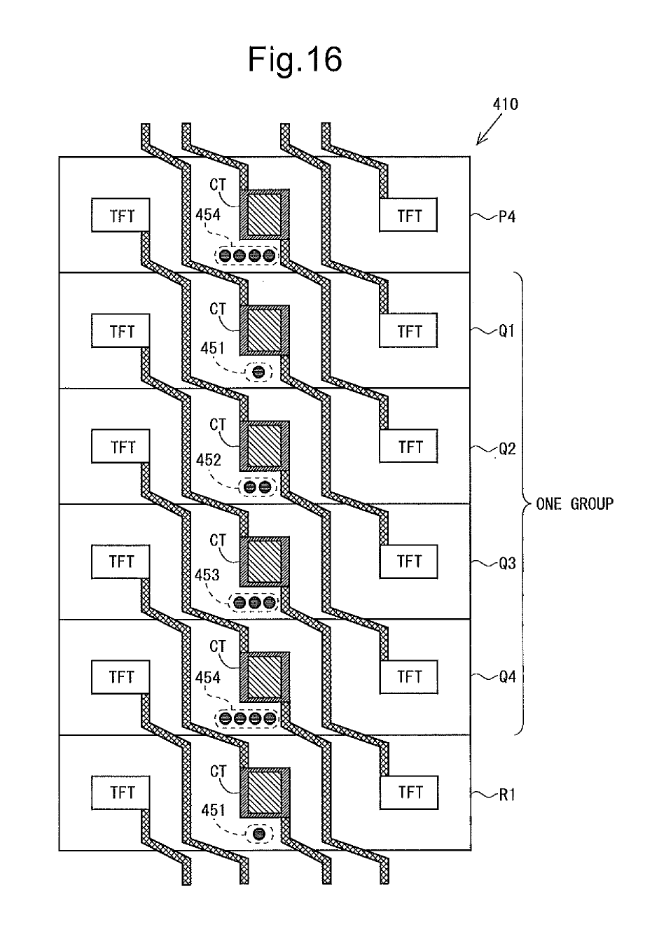

In the above-described embodiment, an inter-stage connecting wiring line connects stages (bistable circuits) adjacent to each other. However, the configuration may be such that odd-numbered stages adjacent to each other or even-numbered stages adjacent to each other are connected to each other by an inter-stage connecting wiring line. In a shift register 410 of such a configuration, the above-described markings may be formed as shown in, for example, FIGS. 16 to 18.

<6.3.1 Fourth Variant>

FIG. 16 is a diagram for describing a layout of markings in a fourth variant of the above-described embodiment. In the present variant, as with the above-described embodiment, markings formed of different numbers of planar-view circular-shaped structures are formed on bistable circuits of four stages included in each group. Specifically, a marking 451 formed of a single planar-view circular-shaped structure is formed on the first stage in each group, a marking 452 formed of two planar-view circular-shaped structures is formed on the second stage in each group, a marking 453 formed of three planar-view circular-shaped structures is formed on the third stage in each group, and a marking 454 formed of four planar-view circular-shaped structures is formed on the fourth stage in each group. All of the planar-view circular-shaped structures forming the markings 451 to 454 are provided below their respective contacts CT when viewed in planar fashion.

<6.3.2 Fifth Variant>

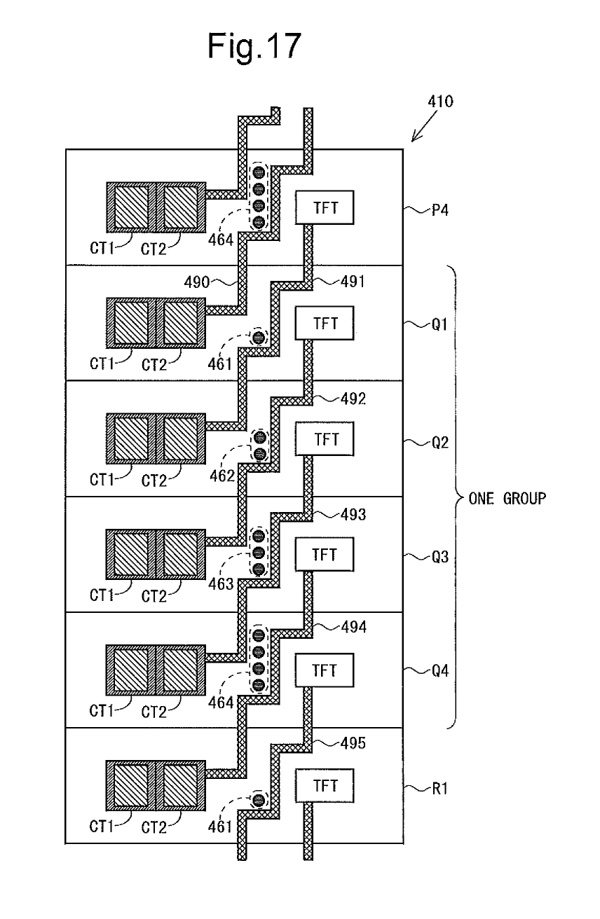

FIG. 17 is a diagram for describing a layout of markings in a fifth variant of the above-described embodiment. In the present variant, a marking is implemented by a planar-view circular-shaped structure(s) formed in a region between two adjacent inter-stage connecting wiring lines. Specifically, for the first stage in each group, a marking 461 is implemented by a single planar-view circular-shaped structure provided in a region between an inter-stage connecting wiring line 490 connecting the first stage to a stage immediately before a previous stage to the first stage and an inter-stage connecting wiring line 491 connecting the previous stage to the first stage to the second stage. For the second stage in each group, a marking 462 is implemented by two planar-view rectangular-shaped structures provided in a region between the inter-stage connecting wiring line 491 connecting the second stage to a stage immediately before a previous stage to the second stage and an inter-stage connecting wiring line 492 connecting the first stage to the third stage. For the third stage in each group, a marking 463 is implemented by three planar-view rectangular-shaped structures provided in a region between the inter-stage connecting wiring line 492 connecting the first stage to the third stage and an inter-stage connecting wiring line 493 connecting the second stage to the fourth stage. For the fourth stage in each group, a marking 464 is implemented by four planar-view rectangular-shaped structures provided in a region between the inter-stage connecting wiring line 493 connecting the second stage to the fourth stage and an inter-stage connecting wiring line 494 connecting the third stage to a subsequent stage to the fourth stage.

Meanwhile, in many cases, circuit elements are not arranged in a close-packed manner near a region where an inter-stage connecting wiring line is formed, and thus a region on a substrate is not efficiently used. In view of this, by employing a configuration in which, as in the present variant, a structure(s) of a planar-view circular shape, etc., is provided in a region between two adjacent inter-stage connecting wiring lines, a marking can be formed on each stage of a shift register 410 without increasing a picture-frame.

<6.3.3 Sixth Variant>

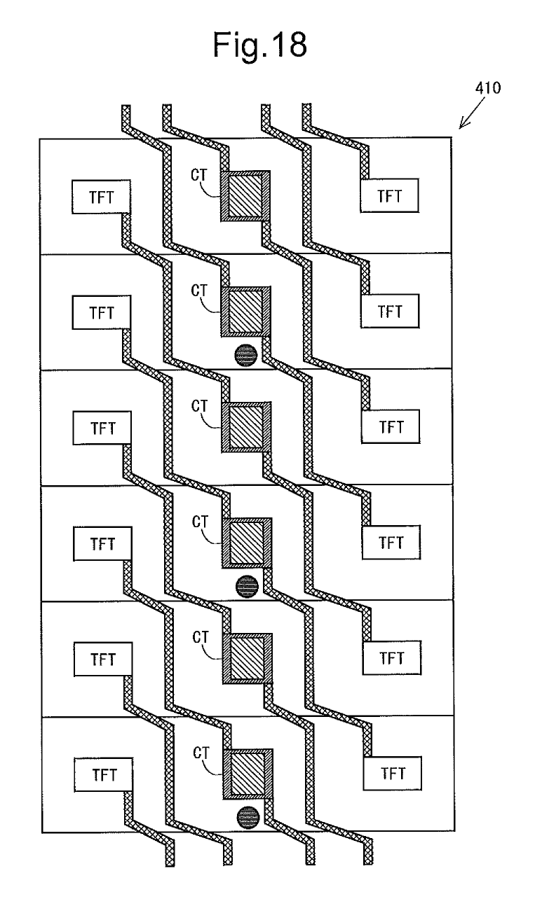

FIG. 18 is a diagram for describing a layout of markings in a sixth variant of the above-described embodiment. In the present variant, a single planar-view circular-shaped structure is provided only on even-numbered stages of a shift register 410. Namely, in the present variant, odd-numbered stages and even-numbered stages are distinguished from each other by whether there is a planar-view circular-shaped structure. As such, according to the present variant, a gate driver 400 is implemented that includes the shift register 410 in which odd-numbered stages and even-numbered stages can be distinguished from each other with a simple configuration.

<7. Others>

Although in the above-described embodiment description is made using an example in which the shift register 410 operates based on 4-phase clock signals, the present invention is not limited thereto. In a shift register 410 that operates based on k-phase clock signals (k is a positive integer), with k stages as one group, different types of markings may be provided on respective k bistable circuits included in each group and the same type of marking may appear every k stages.

In addition, although in the above-described embodiment a marking is implemented by a metal that forms a gate electrode or a source electrode/drain electrode of a thin film transistor, the present invention is not limited thereto. For example, a marking may be implemented by applying a color to a circuit board with ink.

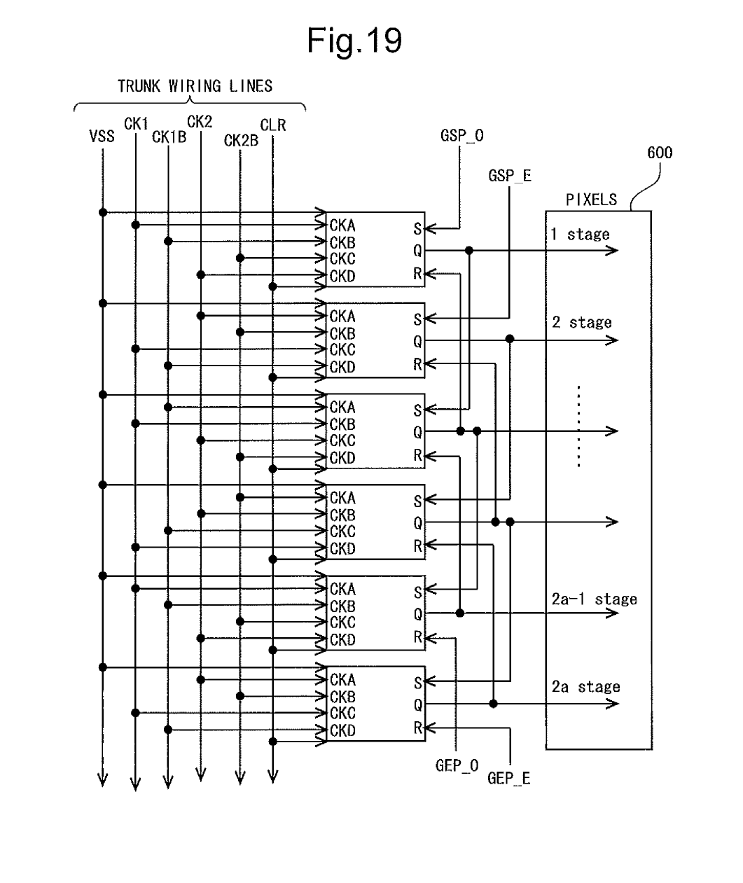

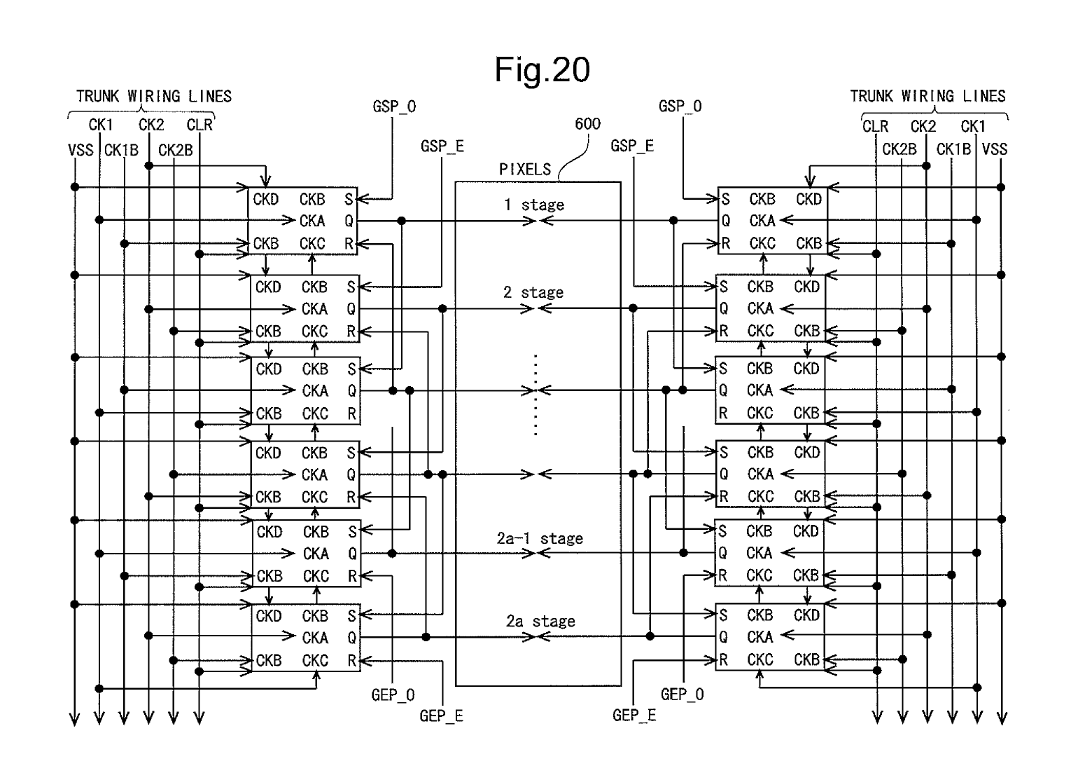

Furthermore, even in a configuration in which, as shown in FIG. 19, each bistable circuit in a shift register receives all clock signals from trunk wiring lines or a configuration in which, as shown in FIG. 20, gate drivers are disposed on both sides of a display unit 600, the present invention can be applied in the same manner as in the above-described embodiment.

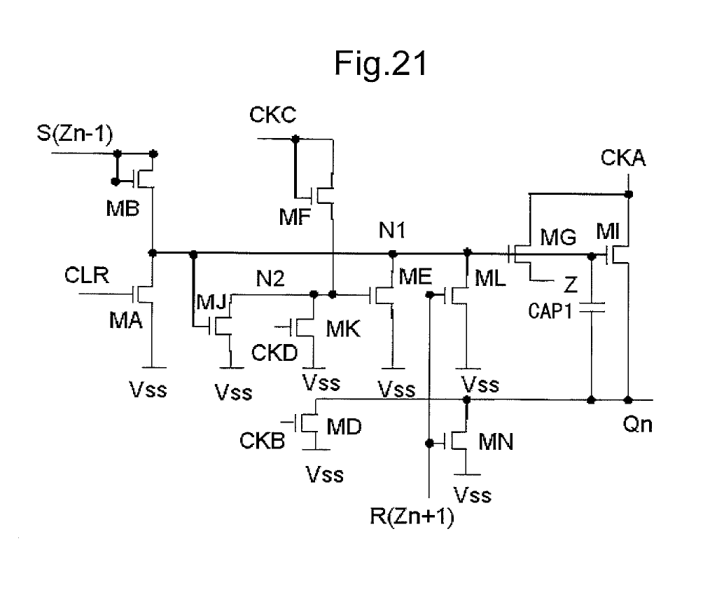

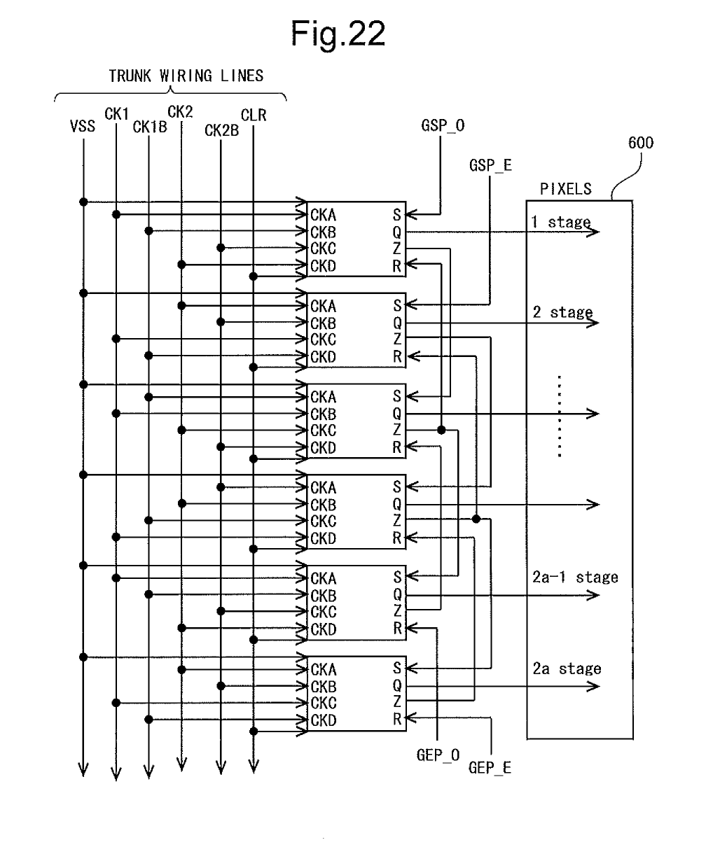

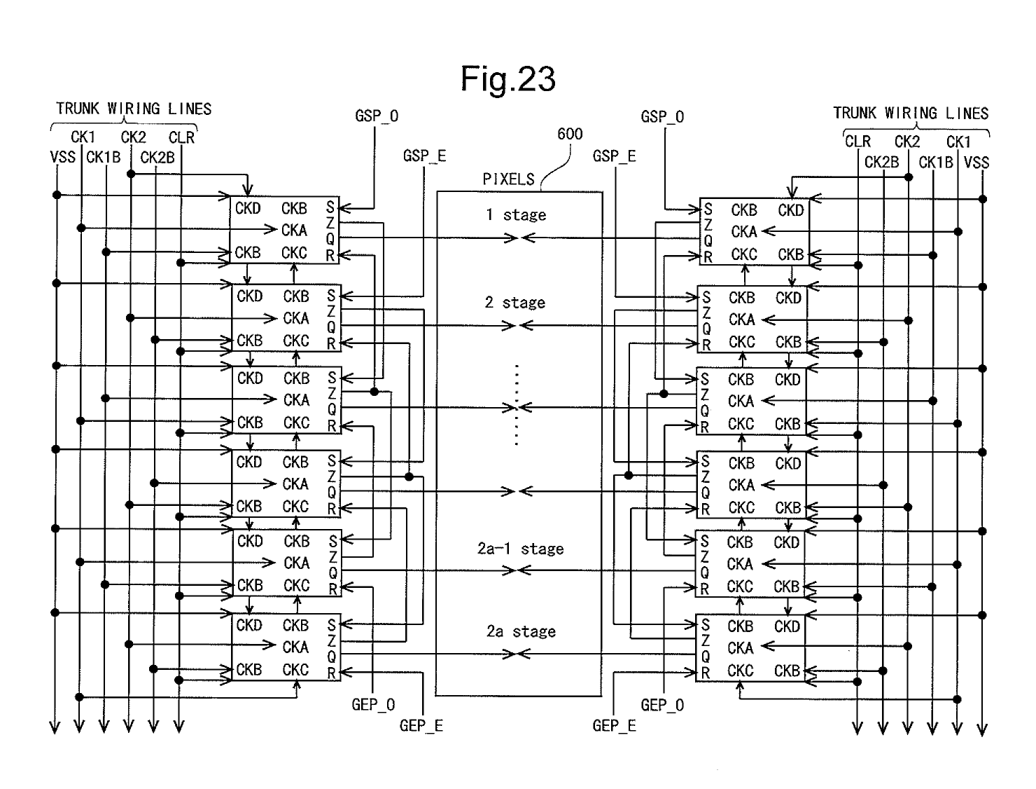

Although in the above-described embodiment a state signal Q outputted from each bistable circuit serves as a set signal S and a reset signal R for other bistable circuits, the present invention is not limited thereto. For example, the configuration may be such that, as shown in FIG. 21, a thin film transistor MG for generating a set signal S and a reset signal R is included in a bistable circuit. In the configuration shown in FIG. 21, an output signal Z from an output terminal connected to the source terminal of a thin film transistor MG in a certain bistable circuit serves as a set signal S and a reset signal R for other bistable circuits. This configuration is effective when adopted to a large panel in which the loads in pixel circuit portions are large. The reason for this is as follows. In a large panel, waveform rounding occurs in a state signal Q due to a large load in a pixel circuit portion. Hence, when the state signal Q is used as a set signal S and a reset signal R, abnormalities may occur in the operation of a shift register. In this regard, according to the configuration shown in FIG. 21, an output signal Z outputted from a certain bistable circuit can be provided to other bistable circuits through a wiring line that is not connected to a pixel circuit portion, as a set signal S and a reset signal R. Hence, even in a large panel, abnormalities in the operation of a shift register due to waveform rounding do not occur. Note that in the case of adopting this configuration, for example, the configuration of a gate driver shown in FIG. 19 is changed to a configuration such as that shown in FIG. 22, and the configuration of a gate driver shown in FIG. 20 is changed to a configuration such as that shown in FIG. 23.

Furthermore, although in the above-described embodiment description is made using a liquid crystal display device as an example, the present invention is not limited thereto. The present invention can also be applied to other display devices such as an organic EL (Electro Luminescence).

### DESCRIPTION OF REFERENCE CHARACTERS

200: DISPLAY CONTROL CIRCUIT

300: SOURCE DRIVER (VIDEO SIGNAL LINE DRIVE CIRCUIT)

400: GATE DRIVER (SCANNING SIGNAL LINE DRIVE CIRCUIT)

410: SHIFT REGISTER

411, 413, 416, 417, and 491 to 494: INTER-STAGE CONNECTING WIRING LINE

421 to 424, 431 to 434, 441 to 444, 451 to 454, and 461 to 464: MARKING (MARK)

600: DISPLAY UNIT

CT, CT1, and CT2: CONTACT

1. A scanning signal line drive circuit of a display device that drives a plurality of scanning signal lines arranged in a display unit, the circuit comprising:
a shift register including a plurality of stages and sequentially shifting a pulse provided to a first stage from the first stage to a last stage based on a plurality of clock signals provided to each stage, the shift register being for driving the plurality of scanning signal lines, wherein
the shift register is grouped every k consecutive stages,
k stages included in each group of the shift register are provided with different types of marks from each other, and
the marks are of same types every k stages of the shift register.

2. The scanning signal line drive circuit according to claim 1, further comprising a clock signal trunk wiring line including a plurality of signal lines that transmit k clock signals as the plurality of clock signals, wherein
each stage of the shift register operates based on the k clock signals.

3. The scanning signal line drive circuit according to claim 2, wherein
each stage of the shift register includes:
an inter-stage connecting wiring line for receiving a clock signal other than clock signals received from the clock signal trunk wiring line, from a different stage than the stage; and
a contact that electrically connects a wiring line formed on the stage to the inter-stage connecting wiring line, and
in the stages of the shift register, the marks are provided near their respective inter-stage connecting wiring lines.

4. The scanning signal line drive circuit according to claim 2, wherein
each stage of the shift register includes:
an inter-stage connecting wiring line for receiving a clock signal other than clock signals received from the clock signal trunk wiring line, from a different stage than the stage; and
a contact that electrically connects a wiring line formed on the stage to the inter-stage connecting wiring line, and
in the stages of the shift register, the marks are provided near their respective contacts.

5. The scanning signal line drive circuit according to claim 4, wherein positions of the marks with reference to their respective contacts are different for k stages included in each group of the shift register.

6. The scanning signal line drive circuit according to claim 1, wherein shapes of the marks are different for k stages included in each group of the shift register.

7. The scanning signal line drive circuit according to claim 1, wherein
k stages included in each group of the shift register are provided with different numbers of predetermined structures as the marks, and
the structures are same in number every k stages of the shift register.

8. The scanning signal line drive circuit according to claim 1, wherein the k is 2 or 4.

9. The scanning signal line drive circuit according to claim 1, wherein
each stage of the shift register includes a thin film transistor, and
each of the marks is formed of a same metal as a metal that forms a gate electrode of the thin film transistor, or a same metal as a metal that forms a source electrode and a drain electrode of the thin film transistor.

10. The scanning signal line drive circuit according to claim 1, wherein the circuit is formed on a same substrate as the display unit.

11. A display device including the display unit and comprising a scanning signal line drive circuit according to claim 1.
